(19) United States
(12) Patent Application Publication
(10) Pub. No.: US 2026/0184528 A1
(43) Pub. Date: Jul. 2, 2026

(54) MEDIA DEFLECTOR FOR A ROOF PLATE OF AN AUTOMATED TELLER MACHINE

(71) Applicant: Cardtronics USA, Inc,, Atlanta, GA (US)

(72) Inventors: Scott Low Colston, Dundee (GB); Zelin Liu, Monifieth (GB); Callum Jacklin, Dundee (GB); Jamie Kenneth Stewart, Dundee (GB); Matthew Bowen, Perth (GB)

(21) Appl. No.: 19/006,500

(22) Filed: Dec. 31, 2024

(51) Int. Cl. B65H 31/26; G07D 11/13; G07D 11/14

(52) U.S. Cl. CPC B65H 31/26; G07D 11/13; G07D 11/14; B65H 2404/653; B65H 2405/115; B65H 2701/1912; G07D 2211/00

(57) ABSTRACT

A media deflector mounted to a roof plate of an automated teller machine is described herein. The media deflector includes a set of fingers attached to a spar. The spar can be configured to connect to the roof plate and rotate between two positions, with the first position positioning the fingers to deflect media and the second position enabling the media to be held.

### TECHNICAL FIELD

Embodiments described herein generally relate to automated teller machines and more specifically to a media deflector for a roof plate of an automated teller machine.

### BACKGROUND

An Automated Teller Machine (ATM) is an electronic device configured to provide service to users without the need for direct interaction with a person. In the context of banking services, an ATM is typically configured to dispense media (e.g., bank notes or specie), receive media (e.g., bank notes, specie, checks, etc.), or perform other transactions (e.g., transferring money between accounts, pay bills, etc.). An ATM includes both hardware and software components, enabling secure and efficient financial transactions. Usually. the hardware includes a card reader for identifying user accounts through magnetic stripe or chip-based debit or credit cards, a keypad or touchscreen for personal identification number (PIN) input and navigation, and a dispenser for media (e.g., bank notes). Other components can include a receipt printer, deposit slot, or a display screen for user interaction. The software within an ATM is usually embedded with encryption protocols and operates on secure communication networks to ensure data privacy and protection. ATMs are connected to networks (e.g., banking networks or central servers), enabling real-time account verification and transaction processing. ATMs operate using a combination of standardized protocols, such as ISO 8583, for transaction messaging and robust operating systems, often customized for security and reliability. ATMs enable customers to perform various banking tasks such as cash withdrawal, deposits, fund transfers, balance inquiries, or bill payments.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an ATM, according to an embodiment.

FIGS. 2A and 2B illustrate an example of a pocket assembly, according to an embodiment.

FIG. 3 illustrates an example of a media deflector, according to an embodiment.

FIG. 4 illustrates an example of a roof plate with a media deflector, according to an embodiment.

FIG. 5 illustrates an example of a media deflector, according to an embodiment.

FIG. 6 illustrates an example of a roof plate with a media deflector, according to an embodiment.

### DETAILED DESCRIPTION

As an ATM prepares to dispense media to a user, a mechanism can be employed in which the media is propelled through the air to a stacking location in a top compartment of a pocket assembly. To neatly stack the media, the ATM can use a deflector plate that interposes in the path of the media to deflect the media onto the stacking location. In other words, when notes are stacking in the top compartment, the notes are shot into the media deflector (e.g., deflector arm) to push them down into the stacking location. The interaction with the media deflector reduces the speed of the media, usually resulting a more controlled (e.g., neat) stacking of media.

A problem can arise when the pocket is exposed to a user (e.g., just before or upon dispensing media); the user reaches into the top compartment and breaks the media deflector. Common types of failures include dislodging a guide arm of the media deflector from a guide path in the roof plate and breaking a hinge of the media deflector with the roof plate.

A few different approaches are described herein to address these issues. For example, a stop can be added to the distal end of the guide arm to prevent the guide arm from being dislodged from the roof plate. In an example, the radius of the hinge can be increased, or the materials of the media deflector change to increase the bending tolerance of the media deflector.

In an example, the media deflector is implemented with a wind-finger design, in which the media deflector rotates from a deflecting position to a holding position. This can reduce the complexity of the media deflector, while effectively removing the components that have failed when used to hold media for dispensing. Another advantage to this approach includes greater coverage of both a flight path for media to the stacking location as well as wind finger coverage because the same part performs both functions rather than two different systems common today. Additional details and examples are provided below.

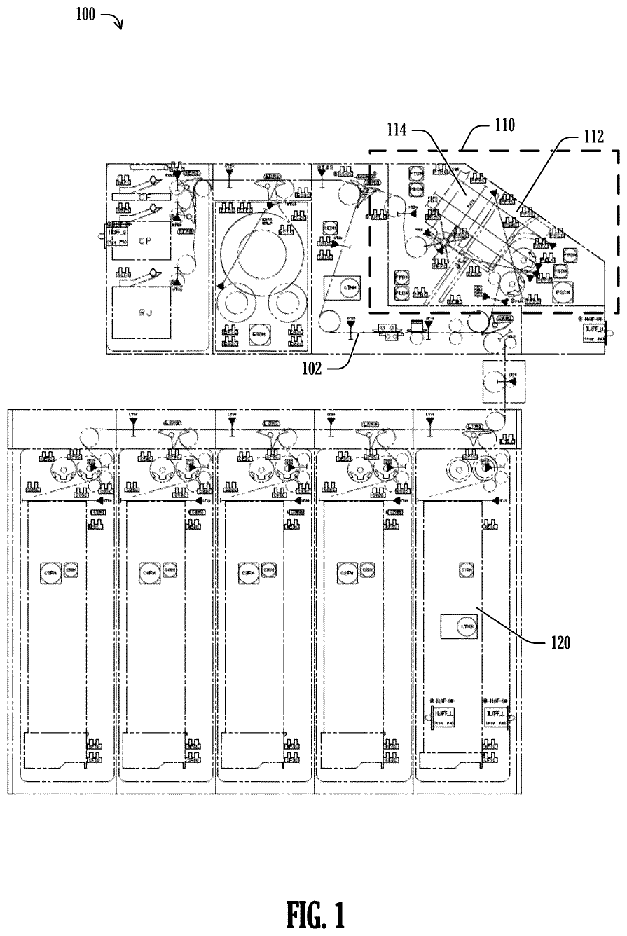

FIG. 1 illustrates an example of an ATM 100, according to an embodiment. The ATM 100 includes a pocket assembly 110. Here, the pocket assembly 110 is divided into a bottom compartment 112 and a top compartment 114. The pocket assembly 110 serves as the primary area for receiving and processing media (e.g., bank notes, receipts, etc.) within the ATM 100. The bottom compartment 112 and the top compartment 114 are configured to facilitate movement or storage of media during various stages of a transaction.

The ATM 100 can include one or more note storage compartments 120 (e.g., cassettes). A belt 102 or other transport mechanism can be coupled between various components in the pocket assembly 110 and the note storage compartments 120. The note storage compartments 120 are connected to the pocket assembly 110 and provide a secure location for storing media in the ATM 100 before, during, or after processing. The note storage compartments 120 can be configured to organize ATM media to, for example, be ready for future transactions or for collection. The connection between the pocket assembly 110 and the note storage compartment 120 enables efficient transfer or storage of media within the ATM 100.

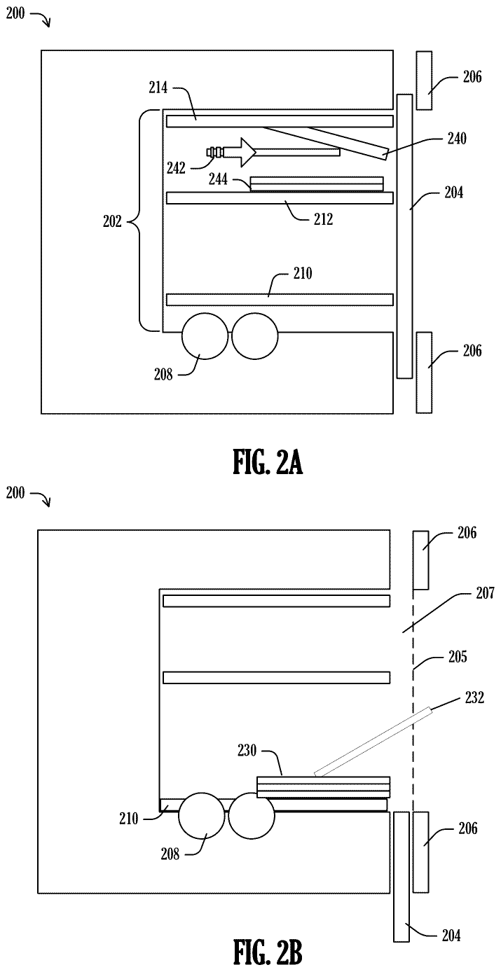

FIG. 2A and FIG. 2B illustrate an example of a pocket assembly 200 similar to the pocket assembly 110 illustrated in FIG. 1, according to an embodiment. As illustrated, the pocket assembly 200 includes a pocket 202, which serves as the primary area to receive media. The fascia 206 is located on an exterior surface of the ATM, surrounding the pocket 202 and providing an interface for users. The shutter 204 is movable to, as illustrated in FIG. 2A cover the pocket 202 when in a closed position or to reveal the pocket 202 to a user in an open position as illustrated in FIG. 2B. Within the pocket is a staging plate 210 and a pusher plate 212 that can move up and down to facilitate the handling of media.

In the position shown in FIG. 2A, the staging plate 210 and the pusher plate 212 define a bottom compartment, like the bottom compartment 112 from FIG. 1. In operation, a stack of media 230 is inserted onto the staging plate 210 and the staging plate is lowered as illustrated in FIG. 2B. One or more rollers 208 can protrude through the staging plate 210 in FIG. 2B and are used to transport individual pieces of the media 232 within the ATM. In an example, the pusher plate 212 is also lowered to apply pressure to the stack of media 230 (e.g., a stack of bank notes) while the rollers 208 engage the stack, although not shown in FIG. 2B.

The roof plate 214 is positioned above the pusher plate 212 in the pocket 202. In an example, the roof plate 214 (e.g., top plate) is also movable up and down within the pocket 202. In an example, the roof plate 214 does not move, but includes one or more movable portions 240, such as a deflector to deflect a moving piece of media 242 into a stack 244 in the top compartment, to, for example, dispense or return media to a user, when the shutter 204 is open.

A slot 207 is configured to guide the shutter 204 between the closed (e.g., extended) position illustrated in FIG. 2A and the open (e.g., retracted) position illustrated in FIG. 2B. An edge of the slot 207 is shown by dashed line 205, and the slot 207 is located between the pocket 202 and the fascia 206 of the ATM.

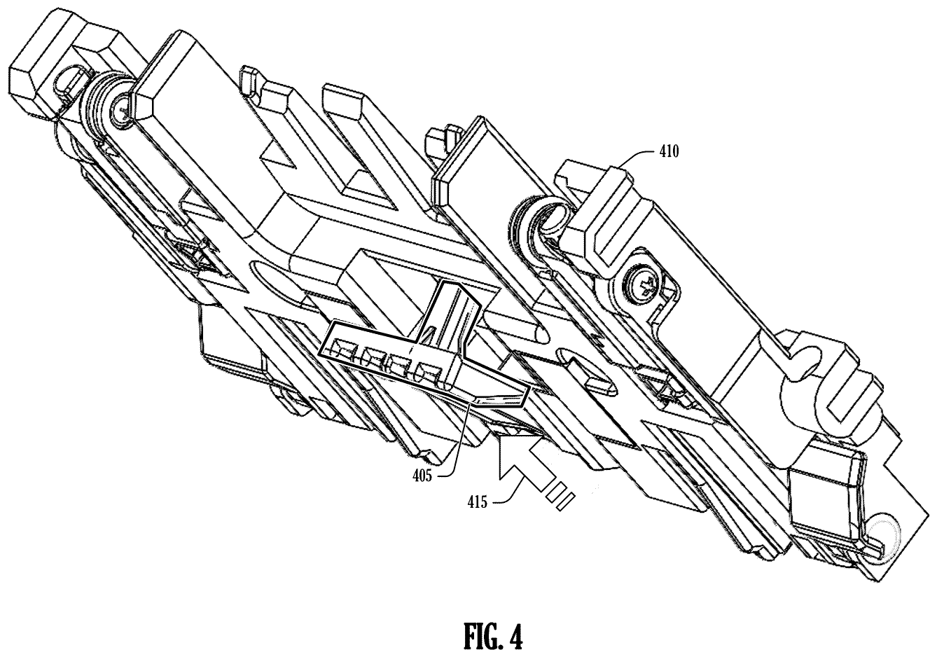

FIG. 4 illustrates an example of a media deflector 300, according to an embodiment. The illustrated media deflector includes a deflector portion 303. The deflector portion 303 includes a first side 305 (obscured in the present view) configured to interact with media as media is propelled into a top compartment of an ATM pocket assembly. The deflector portion 303 includes a second side 307 that is at least partially parallel to the first side 305. The first side 305 can be considered the bottom of the deflector portion 303 and the second side 307 can be considered the top of the deflector portion 303 of the deflector 300. Although the examples here refer to the first side 305 and the second side 307 being parallel, this is not strictly required. Rather, the two sides bound the top and bottom of the deflector portion 303. The deflector portion also includes a third side 309 (e.g., a back of the deflector portion 303) that is perpendicular, or otherwise not parallel, to the first side 305. a second side parallel to the first side.

The deflector portion 303 includes a guide arm 310 protruding from the second side 307. The guide arm 310 is configured to pass through an opening (e.g., a guide path) in a roof plate. FIG. 4 illustrates an example of a deflector 405 mounted on a roof plate 410 to demonstrate the positioning of a guide arm and guide path when so mounted. The guide arm 310 includes a stop 315 as part of a distal end of the guide arm 310. The stop 315 has a cross section that is greater than a portion of the guide arm 310 that passes through the opening of the guide path in an axis of the portion of the guide arm that passes through the opening. This increased cross section of the stop 315 is configured to prevent the guide arm 310 from being pulled free of the guide path of the roof plate by interacting with a corresponding feature of the roof plate, such as a top of the roof plate or other feature along the guide path. In an example, the stop has a radius 335 in a direction of pivot provided by the hinge. This radius can help to pass the stop 315 through the guide path of the roof plate while still helping to prevent the guide arm 310 from being pulled free of the guide path by a user.

The deflector 300 includes a hinge arm 320 protruding from the third side 309 and configured to form a hinge 325 with the roof plate. As illustrated, the media deflector 300 includes a mounting bracket 330—though the mounting bracket 330 could be part of the roof plate—that is configured to be secured to the roof plate and to form part of the hinge 325. Accordingly, during assembly, the mounting bracket 330 is fixed to the roof plate and enables the deflector portion 303 to pivot about the hinge 325. In an example, a distal portion of the hinge arm 320—e.g., a portion of the hinge arm 320 that is towards the hinge 325 and away from the deflector portion 303—includes a radius on breakpoints for the hinge 325. Here, the distal portion of the hinge arm 320 is rounded to help prevent the hinge arm 320 from catching and breaking if a user interacts with the media deflector 300.

In an example, the deflector portion 303, the guide arm 310, and the hinge arm 320 are formed as a single piece of plastic via an injection molding process. In an example, another process can be used to form these components into a single manufactured product. These other processes can include additive manufacturing (e.g., three-dimensional printing), casting, forging etc. In an example, the plastic does not include fiberglass, or other fibers, as reinforcement. This can increase the flexibility of the media deflector 300 if a user interacts with the media deflector 300 to reduce the likelihood that any part of the media deflector 300 breaks during such interactions.

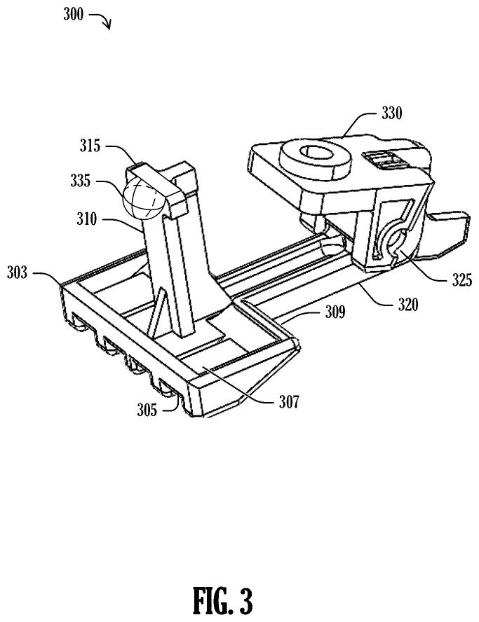

FIG. 4 illustrates an example of a roof plate 410 with a deflector 405, according to an embodiment. This illustration demonstrates the mounting position of the deflector 405 in the roof plate 410. The deflector 405 has a hinge with the roof plate 410 that is hidden by the deflector 405 in this illustration. The deflector 405 includes a guide arm extending through a guide path (e.g., cavity) in the roof plate 410. When in operation, the deflector 405 is configured to rotate freely on the hinge with the guide arm maintain a maximum downward (e.g., away from the roof plate) position and to maintain lateral positioning in a flight path of media 415 being stacked. The deflector 405 can include the features of the media deflector 300 illustrated in FIG. 3.

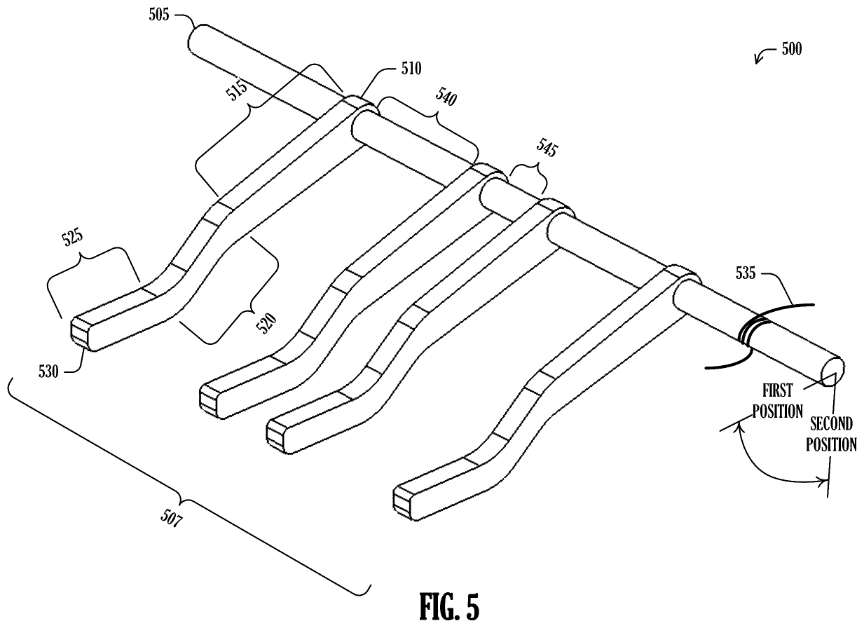

FIG. 5 illustrates an example of a media deflector 500, according to an embodiment. The illustrated media deflector 500 includes a spar 505 configured to connect to a roof plate and to rotate through a first position to a second position with respect to the roof plate when connected to the roof plate.

The media deflector 500 includes a set of fingers 507 connected to the spar 505. A finger 510 in the set of fingers 507 includes a proximal portion 515 configured to connect to the spar, a distal portion 525, and a connecting portion 520. The connecting portion 520 is configured to connect the proximal portion 515 and the distal portion 525 while positioning the distal portion 525 on an axis different than the proximal portion 515.

In an example, the set of fingers 507 moves together with the spar 505 when the spar rotates. In an example, each finger in the set of fingers 507 is fixed to the spar 505 such that the set of fingers 507 rotate with the spar 505. In an example, the set of fingers 507 includes four fingers. In an example, fingers in the set of fingers 507 have at least two spacing sizes between fingers on the spar 505. This is illustrated as a first spacing 540 being larger than a second spacing 545 in FIG. 5.

In an example, the connecting portion 520 is configured to deflect the media when the spar 505 is rotated to the first position. Much like the media deflector 405 illustrated in FIG. 4, the connecting portion 520 is configured to interact with propelled media along a flight path of the media (e.g., the flight path of media 415 or the flight path of media 620) when the fingers are in the first position (e.g., an “up” position).

In an example, the media deflector 500 operates (e.g., is configured to function as) a wind finger when rotated towards the second position. Here, a wind finger operates to put some pressure on the media to help prevent a gust, breeze, or other motion of the air from disturbing (e.g., scattering) the stacked media when, for example, being dispensed to the user. Thus, a complete rotation of the spar 505 to the second position may not be achieved as the distal portion 525 presses into the stacked media. Accordingly, in an example, the presence of media prevents rotation (e.g., complete rotation of the spar 505) to the second position because further rotation towards the second position is prevented by an interaction between the finger 510 in the set of fingers 507 and the media.

In an example, the media deflector 500 includes a spring 535 coupled to the spar 505 and the roof plate to apply a torque towards the second position. Here, the spring 535 provides a configurable force applied to the distal portion 525 to the finger 510 to hold media. In an example, the distal portion 525 of the finger 510 has a radius 530 at a distal end in the direction of rotation of the spar 505. This radius provides a smoother interaction with media at different engagement angles (e.g., due to a more or less media in the media stack).

In an example, the spar 505 and the set of fingers are formed as a single piece of plastic via an injection molding process. In an example, another process can be used to form these components into a single manufactured product. These other processes can include additive manufacturing (e.g., three-dimensional printing), casting, forging etc. In an example, the plastic does not include fiberglass, or other fibers, as reinforcement. This can increase the flexibility of the media deflector 500 if a user interacts with the media deflector 500 to reduce the likelihood that any part of the media deflector 500 breaks during such interactions.

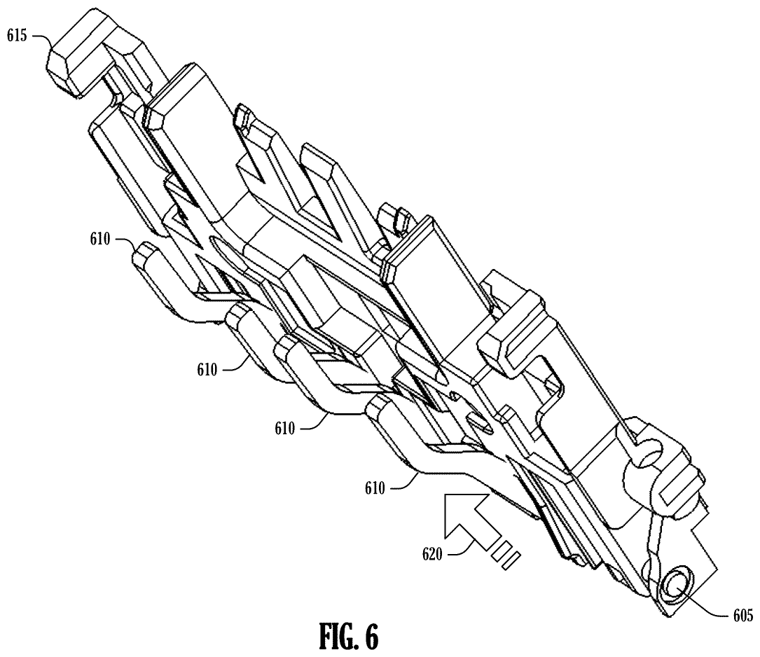

FIG. 6 illustrates an example of a roof plate 615 with a media deflector, according to an embodiment. The media deflector can conform to the elements of the media deflector 500 illustrated in FIG. 5. The media deflector includes a set of fingers 610 and a spar 605. The spar 605 is configured to mount the media deflector to the roof plate 615 and to rotate the set of fingers 610 between a first position and a second position. As noted above, when in the first position, the set of fingers 610 impeded the flight path 620 of propelled media to stack the media. When rotated toward the second position, the spar 605 imparts a torque upon the set of fingers 610 to put pressure on the stacked media. Thus, when rotated toward the second position, the set of fingers 610 function as wind fingers to secure the stack of media.

### Additional Notes & Examples

Example 1 is a media deflector for a roof plate of an automated teller machine, the media deflector comprising: a spar configured to: connect to the roof plate; and rotate, through a first position to a second position, with respect to the roof plate when connected to the roof plate; and a set of fingers connected to the spar, a finger in the set of fingers including: a proximal portion configured to connect to the spar; a distal portion; and a connecting portion configured to: connect the proximal portion and the distal portion; and position the distal portion on an axis different than the proximal portion.

In Example 2, the subject matter of Example 1, wherein the connecting portion is configured to deflect media when the spar is rotated to the first position.

In Example 3, the subject matter of any of Examples 1-2, wherein the media deflector operates as a wind finger when rotated towards the second position.

In Example 4, the subject matter of Example 3, wherein presence of media prevents rotation to the second position, and wherein rotation towards the second position is prevented by an interaction between a finger in the set of fingers and the media.

In Example 5, the subject matter of Example 4 comprising a spring coupled to the spar and the roof plate to apply a torque towards the second position.

In Example 6, the subject matter of any of Examples 1-5, wherein the spar and the set of fingers are formed as a single piece of plastic via an injection molding process.

In Example 7, the subject matter of any of Examples 1-6, wherein the set of fingers includes four fingers.

In Example 8, the subject matter of any of Examples 1-7, wherein the distal portion of the finger in the set of fingers has a radius at a distal end in a direction of rotation of the spar.

In Example 9, the subject matter of any of Examples 1-8, wherein fingers in the set of fingers have at least two spacing sizes between fingers on the spar.

Example 10 is a media deflector for a roof plate of an automated teller machine, the media deflector comprising: a deflector portion including: a first side configured to interact with media; a second side parallel to the first side; and a third side perpendicular to the first side and the second side; a guide arm protruding from the second side and configured to pass through an opening in the roof plate, the guide arm including a stop as part of a distal end, the stop having a cross section that is greater than a portion of the guide arm that passes through the opening in an axis of the portion of the guide arm that passes through the opening; and a hinge arm protruding from the third side and configured to form a hinge with the roof plate.

In Example 11, the subject matter of Example 10, wherein the stop has a radius in a direction of pivot provided by the hinge.

In Example 12, the subject matter of any of Examples 10-11, wherein a distal portion of the hinge arm includes a radius on breakpoints for the hinge.

In Example 13, the subject matter of any of Examples 10-12, wherein the deflector portion, the guide arm, and the hinge arm are formed as a single piece of plastic via an injection molding process.

In Example 14, the subject matter of Example 13, wherein the plastic does not include fiberglass as reinforcement.

Example 15 is an automated teller machine comprising: a cassette configured to store media; and a pocket assembly configured to interact with the cassette, the pocket assembly including: a roof plate; and a media deflector for the roof plate, the media deflector comprising: a spar configured to: connect to the roof plate; and rotate, through a first position to a second position, with respect to the roof plate when connected to the roof plate; and a set of fingers connected to the spar, a finger in the set of fingers including: a proximal portion configured to connect to the spar; a distal portion; and a connecting portion configured to: connect the proximal portion and the distal portion; and position the distal portion on an axis different than the proximal portion.

In Example 16, the subject matter of Example 15, wherein the connecting portion is configured to deflect the media when the spar is rotated to the first position.

In Example 17, the subject matter of any of Examples 15-16, wherein the media deflector operates as a wind finger when rotated towards the second position.

In Example 18, the subject matter of Example 17, wherein presence of media prevents rotation to the second position, and wherein rotation towards the second position is prevented by an interaction between a finger in the set of fingers and the media.

In Example 19, the subject matter of Example 18 comprising a spring coupled to the spar and the roof plate to apply a torque towards the second position.

In Example 20, the subject matter of any of Examples 15-19, wherein the spar and the set of fingers are formed as a single piece of plastic via an injection molding process.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-9. (canceled)

10. A media deflector for a roof plate of an automated teller machine, the media deflector comprising:
a deflector portion including:
a first side configured to interact with media;
a second side parallel to the first side; and
a third side perpendicular to the first side and the second side;
a guide arm protruding from the second side and configured to pass through an opening in the roof plate, the guide arm including a stop as part of a distal end, the stop having a cross section dimension that is greater than a portion of the guide arm that passes through the opening in an axis of the portion of the guide arm that passes through the opening; and
a hinge arm protruding from the third side and configured to form a hinge with the roof plate.

11. The media deflector of claim 10, wherein the stop has a radius in a direction of pivot provided by the hinge.

12. The media deflector of claim 10, wherein a distal portion of the hinge arm includes a radius on breakpoints for the hinge.

13. The media deflector of claim 10, wherein the deflector portion, the guide arm, and the hinge arm are formed as a single piece of plastic via an injection molding process.

14. The media deflector of claim 13, wherein the plastic does not include fiberglass as reinforcement.

15. An automated teller machine comprising:
a cassette configured to store media; and
a pocket assembly configured to interact with the cassette, the pocket assembly including:
a roof plate; and
a media deflector for the roof plate, the media deflector comprising:
a deflector portion including:
a first side configured to interact with media;
a second side parallel to the first side; and
a third side perpendicular to the first side and the second side;
a guide arm protruding from the second side and configured to pass through an opening in the roof plate, the guide arm including a stop as part of a distal end, the stop having a cross section dimension that is greater than a portion of the guide arm that passes through the opening in an axis of the portion of the guide arm that passes through the opening; and
a hinge arm protruding from the third side and configured to form a hinge with the roof plate.

16-20. (canceled)

21. The automated teller machine of claim 15, wherein the stop has a radius in a direction of pivot provided by the hinge.

22. The automated teller machine of claim 15, wherein a distal portion of the hinge arm includes a radius on breakpoints for the hinge.

23. The automated teller machine of claim 15, wherein the deflector portion, the guide arm, and the hinge arm are formed as a single piece of plastic via an injection molding process.

24. The automated teller machine of claim 23, wherein the plastic does not include fiberglass as reinforcement.
